(19) United States
(12) Patent Application Publication
(10) Pub. No.: US 2020/0189107 A1
(43) Pub. Date: Jun. 18, 2020

(54) ARTIFICIAL INTELLIGENCE MOVING ROBOT AND METHOD FOR CONTROLLING THE SAME

(71) Applicant: LG ELECTRONICS INC., Seoul (KR)

(72) Inventors: Hyungkook JOO, Seoul (KR); Hyunsup SONG, Seoul (KR); Kyungman YU, Seoul (KR)

(73) Assignee: LG ELECTRONICS INC., Seoul (KR)

(21) Appl. No.: 16/709,439

(22) Filed: Dec. 10, 2019

(30) Foreign Application Priority Data
Dec. 12, 2018 (KR) 10-2018-0160279

(51) Int. Cl. B25J 9/16; B25J 5/00; B25J 19/06; B25J 11/00

(52) U.S. Cl. CPC B25J 9/1676; B25J 5/00; B25J 11/008; B25J 19/061; B25J 9/1697

(57) ABSTRACT

An artificial intelligence (AI) robot and a method for controlling the AI robot, includes detecting a target object changing its position in a travel area after determining a condition of the travel area based on an image captured by an image capturing unit while the AI robot is traveling in the travel area. The AI robot is controlled to travel based on the target object detected.

### CROSS-REFERENCE TO RELATED APPLICATIONS

This application claims the benefit of priority of Korean Application No. 10-2018-0160279, filed on Dec. 12, 2018, the contents of which is hereby incorporated by reference herein in its entirety.

### TECHNICAL FIELD

The present disclosure relates to a moving robot that autonomously travels in a travel area, and a method for controlling the moving robot.

### BACKGROUND ART

Generally, a moving robot is a device that automatically performs a predetermined operation while traveling by itself in a predetermined area without a user's operation. The moving robot senses obstacles located in the area and performs its operation by moving close to or away from such obstacles.

Such a moving robot may include a cleaning robot that carries out cleaning while traveling in the predetermined area, as well as a moving robot that mows a lawn on a bottom of the predetermined area. Generally, lawn mower devices include a riding-type device that moves according to a user's operation to cut a lawn or perform weeding when the user rides on the device, and a work-behind type or hand type device that is manually pushed or pulled by the user to move and cut a lawn. However, since the lawn mower devices move and cut a lawn according to direct operation by a user, the user may inconveniently operate the device directly. Accordingly, research has been conducted on a moving robot-type mower device including elements that cuts a lawn.

Such a moving robot for lawn mowing (lawn mower) operates outdoors rather than indoors, and thus there are many limitations or restrictions in traveling. For example, dynamic obstacles such as a pet and another moving robot may exist in outdoors, and these dynamic obstacles may interfere with traveling or lawn mowing of the moving robot as they are moving. Also, as grass in a travel area is cut by a sharp blade in a rotating manner, an accident may occur if a toddler or a pet in the travel area fails to avoid the moving robot. As for the toddler or pet, an ability to recognize objects is relatively less developed compared to a user of the moving robot. In other words, the dynamic obstacles present in the travel area may affect traveling of the moving robot and safety.

Meanwhile, Korean Patent Laid-Open Publication No. 10-2018-0023303 (Published on Mar. 7, 2018) (hereinafter referred to as “related art document”) discloses a moving robot that senses a fan or a person's foot to avoid while traveling. However, the moving robot disclosed in the related art document is limited to an indoor moving robot, and thus it is not suitable for a lawn mowing robot that travels in an outdoor environment. That is, factors and constraints regarding the outdoor environment are not taken into consideration. Accordingly, a method for controlling a moving robot's traveling that takes dynamic obstacles in the outdoor environment into account is not presented.

Accordingly, in the related art moving robot, traveling of the moving robot is limited by the dynamic obstacles in the outdoor environment and a safety problem is accompanied accordingly, and thus there are limitations in ensuring accuracy, stability, reliability, efficiency, and utility of traveling and operation of the moving robot. In addition, in the field of moving robot technology, in general, a technology for obviating such limitations has not been provided, and thus, a limitation or a problem caused by dynamic obstacles has not been solved.

### DISCLOSURE

### Technical Problem

Therefore, an aspect of the present disclosure is to obviate the above-mentioned problems and other drawbacks.

More particularly, an aspect of the present disclosure is to provide a moving robot that can sense a dynamic obstacle present in a travel area and control traveling in response to the dynamic obstacle detected, and a method for controlling the moving robot.

Another aspect of the present disclosure is to provide a moving robot capable of accurately detecting a dynamic obstacle present in a travel area, and a method for controlling the moving robot.

Still another aspect of the present disclosure is to provide a moving robot capable of traveling in response to a detected dynamic obstacle, and a method for controlling the moving robot.

### Technical Solution

Embodiments disclosed herein provide a moving robot that may detect a dynamic obstacle present is a travel area by an image capturing element (or unit) and control traveling of a main body accordingly, and a method for controlling the moving robot.

In detail, in the moving robot utilizing and employing an artificial intelligence (AI) technology, an object changing its position in the travel area is recognized among objects captured by the image capturing unit, and the recognized object is detected as a dynamic obstacle so as to control the main body to travel according to a result of detecting the dynamic obstacle.

That is, in the moving robot and the method for controlling the moving robot according to the present disclosure, when an object changing its position is detected after determining a condition of the travel area based on an image captured by the image capturing unit while the main body is traveling in the travel area, the main body is controlled to travel in response to the object detected.

Accordingly, in the moving robot and the method for controlling the moving robot according to the present disclosure, a dynamic obstacle present in the travel area is detected, and the main body is controlled to travel accordingly, thereby obviating the above-mentioned problems.

The technical features herein may be implemented as a control element for a moving robot, a method for controlling a moving robot, a method for detecting a dynamic obstacle with a moving robot and a control method of detecting a dynamic obstacle, a moving robot employing AI, a method for detecting a dynamic obstacle using AI, or the like. This specification provides embodiments of the moving robot and the method for controlling the moving robot having the above-described technical features.

In order to achieve the aspects and other advantages of the present disclosure, there is provided a moving robot including a main body, a driving unit moving the main body, an image capturing unit capturing an image around the main body to generate image information regarding a travel area of the main body, and a controller configured to control traveling of the main body by controlling the driving unit and determine a condition of the travel area based on the image information. When a target object changing its position in the travel area is detected after determining the condition of the travel area while the main body is traveling in the travel area, the controller may control the main body to travel in response to the target object.

In order to achieve the aspects and other advantages of the present disclosure, there is also provided a method for controlling a moving robot including a main body, a driving unit moving the main body, an image capturing unit capturing an image around the main body to generate image information regarding a travel area of the main body, and a controller configured to control traveling of the main body by controlling the driving unit and determine a condition of the travel area based on the image information, the method may include generating image information by capturing an image around the main body while the main body is traveling in the travel area, detecting a target object changing its position in the travel area based on the image information, and controlling the main body to travel according to a result of the detection.

### Advantageous Effects

In a moving robot and a method for controlling the moving robot according to the present disclosure, a dynamic obstacle present in a travel area can be detected by an image capturing element capturing an image of the travel area, and traveling of a main body can be controlled accordingly, allowing the moving robot to travel according to a result of detecting the dynamic obstacle.

In addition, in the moving robot and the method for controlling the moving robot according to the present disclosure, a dynamic obstacle present in a travel area can be accurately detected, and thus the moving robot can travel by properly responding according to the dynamic obstacle detected.

Further, in the moving robot and the method for controlling the moving robot according to the present disclosure, a limitation or a restriction in traveling of the moving robot due to a dynamic obstacle, and a safety risk caused by traveling and lawn mowing of the moving robot can be mitigated.

Thus, the moving robot and the method for controlling the moving robot according to the present disclosure can not only obviate limitations of the related art, but also improve accuracy, stability, reliability, efficiency, and utilization in the technical field of moving robots for lawn mowing utilizing and employing artificial intelligence (AI).

### BRIEF DESCRIPTION OF THE DRAWINGS

FIG. 1 is a configuration diagram illustrating one embodiment of a moving robot according to the present disclosure.

FIG. 2 is a configuration view illustrating a moving robot according to the present disclosure.

FIG. 3 is a configuration view illustrating a moving robot according to the present disclosure.

FIG. 4 is a conceptual view illustrating one embodiment of a travel area of the moving robot according to the present disclosure.

FIG. 5 is a conceptual view illustrating a traveling principle of the moving robot according to the present disclosure.

FIG. 6 is a conceptual diagram illustrating a signal flow between devices for determining a position of the moving robot according to the present disclosure.

FIG. 7 is a detailed configuration diagram of the moving robot according to the present disclosure.

FIG. 8 is an exemplary view (a) illustrating an example of a target object in a travel area of the moving robot according to the present disclosure.

FIG. 9 is an exemplary view (b) illustrating an example of a target object in a travel area of the moving robot according to the present disclosure.

FIG. 10 is a flowchart illustrating a process of operation of the moving robot according to an embodiment of the present disclosure.

FIG. 11 is an exemplary diagram illustrating an example in which the moving robot according to the present disclosure travels in response to a target object, in accordance with an embodiment of the present disclosure.

FIG. 12 is an exemplary view (a) illustrating a specific example of traveling in response to a target object according to the moving robot in accordance with an embodiment of the present disclosure.

FIG. 13 is an exemplary view (b) illustrating a specific example of traveling in response to a target object according to the moving robot in accordance with an embodiment of the present disclosure.

FIG. 14 is an exemplary view (c) illustrating a specific example of traveling in response to a target object according to the moving robot in accordance with an embodiment of the present disclosure.

FIG. 15 is a flowchart illustrating a sequence for a method for controlling the moving robot according to the present disclosure.

### MODES FOR CARRYING OUT THE PREFERRED EMBODIMENTS

Hereinafter, embodiments of a moving robot and a method for controlling the moving robot according the present disclosure will be described in detail with reference to the accompanying drawings, and the same reference numerals are used to designate the same/like components and redundant description thereof will be omitted.

In describing technologies disclosed in the present disclosure, if a detailed explanation for a related known function or construction is considered to unnecessarily divert the idea of the technologies in the present disclosure, such explanation has been omitted but would be understood by those skilled in the art. It should be noted that the attached drawings are provided to facilitate understanding of the technical idea disclosed in this specification, and should not be construed as limiting the technical idea by the attached drawings.

Hereinafter, an embodiment of a moving robot (hereinafter referred to as “robot”) according to the present disclosure will be described.

The robot may refer to a robot capable of autonomous traveling, a lawn-mowing moving robot, a lawn mowing robot, a lawn mowing device, or a moving robot for lawn mowing.

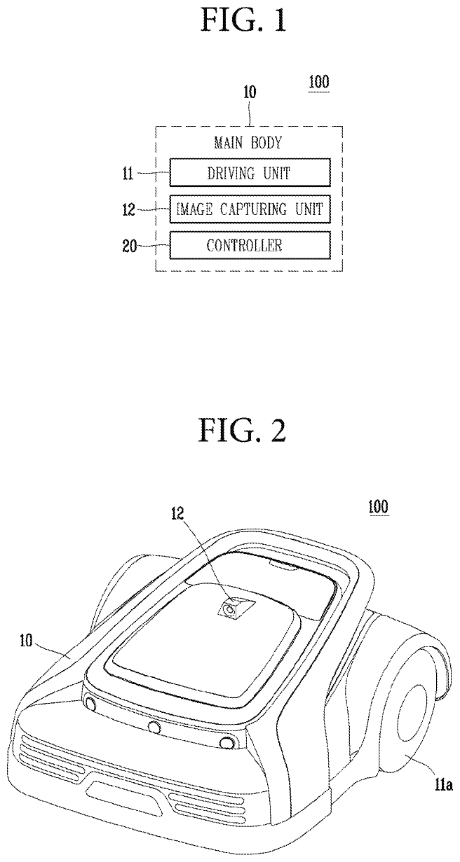

As illustrated in FIG. 1, the robot 100 may include a main body 10, a driving unit 11 moving the main body 10, an image capturing unit 12 capturing an image of a periphery of the main body 10 to generate image information of a travel area 1000 of the main body 10, and a controller 20 controlling the driving unit 11 to control traveling of the main body 10 and determining a condition (or status) of the travel area 1000 based on the image information.

The controller 20 may determine the current position of the main body 10 to control the driving unit 11 such that the main body 10 travels in the travel area 1000, and control the image capturing unit 12 to capture an image of the periphery of the main body 10 while the main body 10 is traveling in the travel area 1000, allowing the condition of the travel area 1000 to be determined based on the image information generated by the image capturing unit 12.

As such, in the robot 100 including the main body 10, the driving unit 11, the image capturing unit 12, and the controller 20, when an object changing its position in the travel area 1000 is detected, which is a target object, after determining the condition of the travel area 1000 while the main body 10 is traveling in the travel area, the controller 20 may control the main body 10 to travel in response to the target object.

That is, in the robot 100, the controller 20 may detect the target object present in the travel area 1000 while the main body 10 is traveling, and control the main body 10 to travel according to a result of the detection.

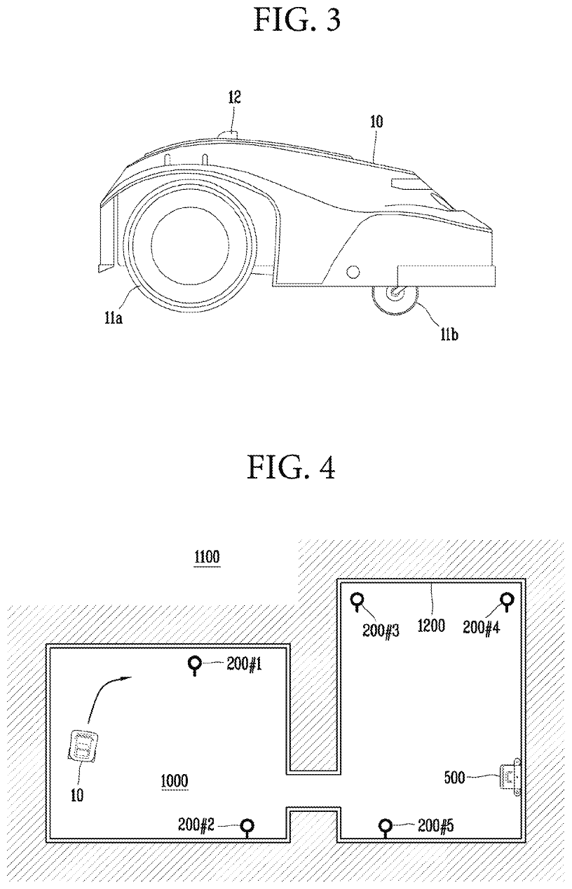

As shown in FIGS. 2 and 3, the robot 100 may be an autonomous traveling robot including the main body 10 configured to be movable so as to cut a lawn. The main body 10 forms an outer shape (or appearance) of the robot 100 and includes one or more elements performing operation such as traveling of the robot 100 and cutting of a lawn. The main body 10 includes the driving unit 11 that may move the main body 10 in a desired direction and rotate the main body 10. The driving unit 11 may include a plurality of rotatable driving wheels. Each of the driving wheels may individually rotate so that the main body 10 rotates in a desired direction. In detail, the driving unit 11 may include at least one main driving wheel 11a and an auxiliary wheel 11b. For example, the main body 10 may include two main driving wheels 11a, and the two main driving wheels may be installed on a rear lower surface of the main body 10.

Accordingly, the robot 100 may travel by itself within the travel area 1000 as illustrated in FIG. 4. The robot 100 may perform particular operation during traveling. Here, the particular operation may be operation of cutting a lawn in the travel area 1000. The travel area 1000 is a target area in which the robot 100 is to travel and operate. A predetermined outside and outdoor area may be provided as the travel area 1000. For example, a garden, a yard, or the like in which the robot 100 is to cut a lawn may be provided as the travel area 1000. A charging apparatus 500 for charging the robot 100 with driving power may be installed in the travel area 1000. The robot 100 may be charged with driving power by docking with the charging apparatus 500 installed in the travel area 1000.

The travel area 1000 may be provided as a boundary area 1200 that is predetermined, as shown in FIG. 4. The boundary area 1200 corresponds to a boundary line between the travel area 1000 and an outside area 1100, and the robot 100 may travel within the boundary area 1200 not to deviate from the outside area 1100. In this case, the boundary area 1200 may be formed to have a closed curved shape or a closed-loop shape. Also, in this case, the boundary area 1200 may be defined by a wire 1200 formed to have a shape of a closed curve or a closed loop. The wire 1200 may be installed in an arbitrary area. The robot 100 may travel in the travel area 1000 having a closed curved shape formed by the installed wire 1200.

As shown in FIG. 2, a transmission device 200 may be provided in plurality in the travel area 1000. The transmission device 200 is a signal generation element configured to transmit a signal to determine position (or location) information of the robot 100. The transmission devices 200 may be installed in the travel area 1000 in a distributed manner. The robot 100 may receive signals transmitted from the transmission devices 200 to determine a current position of the robot 100 based on a result of receiving the signals or determine position information regarding the travel area 1000. In this case, a receiver of the robot 100 may receive the transmitted signals. The transmission devices 200 may be provided in a periphery of the boundary area 1200 of the travel area 1000. Here, the robot 100 may determine the boundary area 1200 based on installed positions of the transmission devices 200 in the periphery of the boundary area 1200 area 1000.

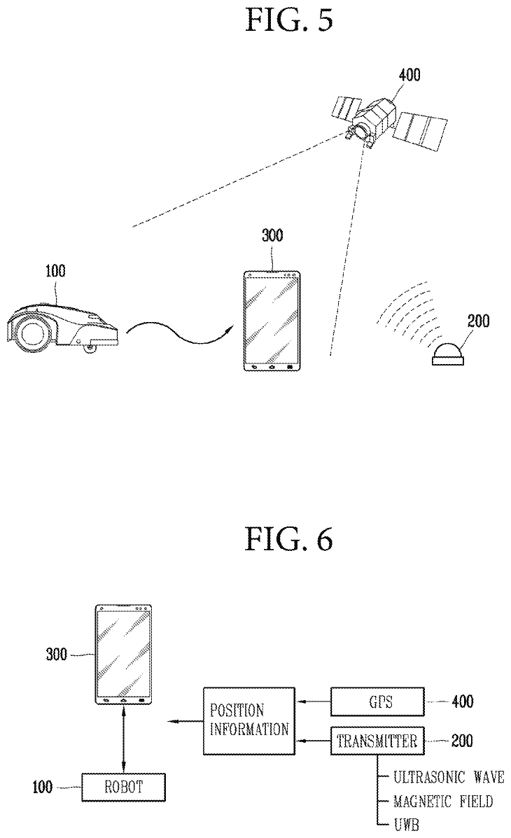

The robot 100 cutting a lawn while traveling in the travel area 1000 shown in FIG. 4 may operate according to a driving mechanism (or principle) as shown in FIG. 5, or a signal may flow between devices for position determination as shown in FIG. 6.

As shown in FIG. 5, the robot 100 may communicate with the terminal 300 moving in a predetermined area, and travel by following a position of the terminal 300 based on data received from the terminal 300. The robot 100 may set a virtual boundary in a predetermined area based on position information received from the terminal 300 or collected while the robot 100 is traveling by following the terminal 300, and set an internal area formed by the virtual boundary as the travel area 1000. When the boundary area 1200 and the travel area 1000 are set, the robot 100 may travel in the travel area 1000 not to deviate from the boundary area 1200. According to cases, the terminal 300 may set the boundary area 1200 and transmit the boundary area 1200 to the robot 100. When the terminal 300 changes or expands an area, the terminal 300 may transmit changed information to the robot 100 so that the robot 100 may travel in a new area. Also, the terminal 300 may display data received from the robot 100 on a screen to monitor operation of the robot 100.

The robot 100 or the terminal 300 may determine a current position by receiving position information. The robot 100 and the terminal 300 may determine a current position based on a signal for position information transmitted from the transmission device 200 in the travel area 1000 or a global positioning system (GPS) signal obtained using a GPS satellite 400. The robot 100 and the terminal 300 may preferably determine a current position by receiving signals transmitted from three transmission devices 200 and comparing the signals with each other. That is, three or more transmission devices 200 may be provided in the travel area 1000.

The robot 100 sets one certain point in the travel area 1000 as a reference position, and then calculates a position while the robot 100 is moving as a coordinate. For example, an initial starting position, that is, a position of the charging apparatus 500 may be set as a reference position. Alternatively, a position of one of the plurality of transmission devices 200 may be set as a reference position to calculate a coordinate in the travel area 1000. The robot 100 may set an initial position of the robot 100 as a reference position in each operation, and then determine a position of the robot 100 while the robot 100 is traveling. With respect to the reference position, the robot 100 may calculate a traveling distance based on rotation times and a rotational speed of a driving wheel, a rotation direction of a main body, etc. to thereby determine a current position in the travel area 1000. Even when the robot 100 determines a position of the robot 100 using the GPS satellite 400, the robot 100 may determine the position using a certain point as a reference position.

As shown in FIG. 6, the robot 100 may determine a current position based on position information transmitted from the transmission device 200 or the GPS satellite 400. The position information may be transmitted in the form of a GPS signal, an ultrasound signal, an infrared signal, an electromagnetic signal, or an ultra-wideband (UWB) signal. A signal transmitted from the transmission device 200 may preferably be a UWB signal. Accordingly, the robot 100 may receive the UWB signal transmitted from the transmission device 200, and determine the current position based on the UWB signal.

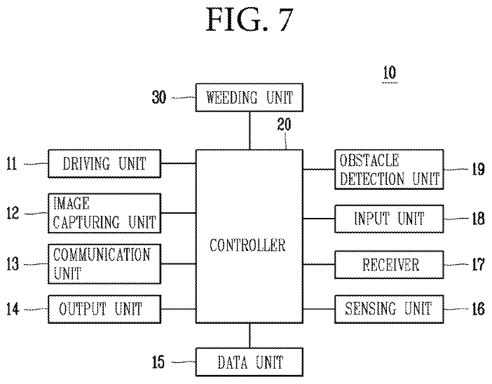

Referring to FIG. 7, the robot 100 operating as described above may include the main body 10, the driving unit 11, the image capturing unit 12, and the controller 20, so that the target object present in the travel area 1000 is detected while the main body 10 is traveling in the travel area 1000 and the main body 10 travels in the travel area 1000 according to a result of detecting the target object. Also, the robot 100 may further include at least one selected from a communication unit 13, an output unit 14, a data unit 15, a sensing unit 16, a receiver 17, an input unit 18, an obstacle detection unit 19, and a weeding unit 30.

The driving unit 11 is a driving wheel included in a lower part of the main body 10, and may be rotationally driven to move the main body 10. That is, the driving unit 11 may be driven so that the main body 10 travels in the travel area 1000. That is, the driving unit 11 may be driven such that the main body 10 travels in the travel area 1000. The driving unit 11 may include at least one driving motor to move the main body 10 so that the robot 100 travels. For example, the driving unit 11 may include a left wheel driving motor for rotating a left wheel and a right wheel driving motor for rotating a right wheel.

The driving unit 11 may transmit information about a result of driving to the controller 20, and receive a control command for operation from the controller 20. The driving unit 11 may operate according to the control command received from the controller 20. That is, the driving unit 11 may be controlled by the controller 20.

The image capturing unit 12 may be a camera capturing an image of a periphery of the main body 10. The image capturing unit 12 may capture an image of a forward direction of the main body 10 to detect an obstacle around the main body 10 and in the travel area 1000. The image capturing unit 12 may be a digital camera, which may include an image sensor (not shown) and an image processing unit (not shown). The image sensor is a device that converts an optical image into an electrical signal. The image sensor includes a chip in which a plurality of photodiodes is integrated. A pixel may be an example of a photodiode. Electric charges are accumulated in the respective pixels by an image, which is formed on the chip by light that has passed through a lens, and the electric charges accumulated in the pixels are converted to an electrical signal (for example, a voltage). A charge-coupled device (CCD) sensor and a complementary metal oxide semiconductor (CMOS) sensor are well known as image sensors. In addition, the image capturing unit 12 may include a Digital Signal Processor (DSP) for the image processing unit to process a captured image so as to generate the image information.

The image capturing unit 12 may transmit information about a result of image capturing to the controller 20, and receive a control command for operation from the controller 20. The image capturing unit 12 may operate according to the control command received from the controller 20. That is, the image capturing unit 12 may be controlled by the controller 20.

The communication unit 13 may communicate with at least one communication target element that is to communicate with the robot 100. The communication unit 13 may communicate with the transmission device 200 and the terminal 200 using a wireless communication method. The communication unit 13 may be connected to a predetermined network so as to communicate with the terminal 300 that controls an external server or the robot 100. When the communication unit 13 communicates with the terminal 300, the communication unit 13 may transmit a generated map to the terminal 300, receive a command from the terminal 300, and transmit data regarding an operation state of the robot 100 to the terminal 300. The communication unit 13 may include a communication module such as wireless fidelity (Wi-Fi), wireless broadband (WiBro), or the like, as well as a short-range wireless communication module such as Zigbee, Bluetooth, or the like, to transmit and receive data.

The communication unit 13 may transmit information about a result of communication to the controller 20, and receive a control command for operation from the controller 20. The communication unit 13 may operate according to the control command received from the controller 20. That is, the communication unit 13 may be controlled by the controller 20.

The output unit 14 may include an output element such as a speaker to output an operation state of the robot 100 in the form of an audio output. The output unit 14 may output an alarm when an event occurs while the robot 100 is operating. For example, when the power is run out, an impact or shock is applied to the robot 100, or an accident occurs in the travel area 1000, an audible alarm may be output so that the corresponding information is provided to a user.

The output unit 14 may transmit information about an operation state to the controller 20 and receive a control command for operation from the controller 20. The output unit 14 may operate according to a control command received from the controller 20. That is, the output unit 14 may be controlled by the controller 20.

The data unit 15 is a storage element that stores data readable by a microprocessor, and may include a hard disk drive (HDD), a solid state disk (SSD), a silicon disk drive (SDD), a read only memory (ROM) a random access memory (RAM), CD-ROM, a magnetic tape, a floppy disk, or an optical data storage device. In the data unit 15, a received signal may be stored, reference data to determine an obstacle may be stored, and obstacle information regarding a detected obstacle may be stored. In the data unit 15, control data that controls operation of the robot 100, data according to an operation mode of the robot 100, position information collected, and information about the travel area 1000 and the boundary area 1200 may be stored.

The sensing unit 16 may include at least one sensor that senses a posture and an operation state (or status) of the main body 10. The sensing unit 16 may include at least one selected from an inclination sensor that detects movement of the main body 10 and a speed sensor that detects a driving speed of the driving unit 11. The inclination sensor may be a sensor that senses posture information of the main body 10. When the main body 10 is inclined forward, backward, leftward or rightward, the inclination sensor may sense the posture information of the main body 10 by calculating an inclined direction and an inclination angle. A tilt sensor, an acceleration sensor, or the like may be used as the inclination sensor. In the case of the acceleration sensor, any of a gyro type sensor, an inertial type sensor, and a silicon semiconductor type sensor may be used. In addition, various sensors or devices capable of detecting movement of the main body 10 may be used. The speed sensor may be a sensor for sensing a driving speed of a driving wheel in the driving unit 11. When the driving wheel rotates, the speed sensor may sense the driving speed by detecting rotation of the driving wheel.

The sensing unit 16 may transmit information of a result of sensing to the controller 20, and receive a control command for operation from the controller 20. The sensing unit 16 may operate according to a control command received from the controller 20. That is, the sensing unit 16 may be controlled by the controller 20.

The receiver 17 may include a plurality of signal sensor modules that transmits and receives the position information. The receiver 17 may include a position sensor module that receives the signals transmitted from the transmission device 200. The position sensor module may transmit a signal to the transmission device 200. When the transmission device 200 transmits a signal using a method selected from an ultrasound method, a UWB method, and an infrared method, the receiver 17 may include a sensor module that transmits and receives an ultrasound signal, a UWB signal, or an infrared signal, in correspondence with this. The receiver 17 may include a UWB sensor. As a reference, UWB radio technology refers to technology using a very wide frequency range of several GHz or more in baseband instead of using a radio frequency (RF) carrier. UWB wireless technology uses very narrow pulses of several nanoseconds or several picoseconds. Since pulses emitted from such a UWB sensor are several nanoseconds or several picoseconds long, the pulses have good penetrability. Thus, even when there are obstacles in a periphery of the UWB sensor, the receiver 17 may receive very short pulses emitted by other UWB sensors.

When the robot 100 travels by following the terminal 300, the terminal 300 and the robot 100 include the UWB sensor, respectively, thereby transmitting or receiving a UWB signal with each other through the UWB sensor. The terminal 300 may transmit the UWB signal to the robot 100 through the UWB sensor included in the terminal 300. The robot 100 may determine a position of the terminal 300 based on the UWB signal received through the UWB sensor, allowing the robot 100 to move by following the terminal 300. In this case, the terminal 300 operates as a transmitting side and the robot 100 operates as a receiving side. When the transmission device 200 includes the UWB sensor and transmits a signal, the robot 100 or the terminal 300 may receive the signal transmitted from the transmission device 200 through the UWB sensor included in the robot 100 or the terminal 300. At this time, a signaling method performed by the transmission device 200 may be identical to or different from signaling methods performed by the robot 100 and the terminal 300.

The receiver 17 may include a plurality of UWB sensors. When two UWB sensors are included in the receiver 17, for example, provided on left and right sides of the main body 10, respectively, the two USB sensors may receive signals, respectively, and compare a plurality of received signals with each other to thereby calculate an accurate position. For example, according to a position of the robot 100, the transmission device 200, or the terminal 300, when a distance measured by a left sensor is different from a distance measured by a right sensor, a relative position between the robot 100 and the transmission device 200 or the terminal 300, and a direction of the robot 100 may be determined based on the measured distances.

The receiver 17 may further include a GPS module for transmitting and receiving a GPS signal from the GPS satellite 400.

The receiver 17 may transmit a result of receiving a signal to the controller 20, and receive a control command for operation from the controller 20. The receiver 17 may operate according to the control command received from the controller 20. That is, the receiver 17 may be controlled by the controller 20.

The input unit 18 may include at least one input element such as a button, a switch, a touch pad, or the like, and an output element such as a display unit, or the like to receive a user command and output an operation state of the robot 100.

The input unit 18 may display a state of the robot 100 through the display unit, and display a control screen on which manipulation or an input is applied for controlling the robot 100. The control screen may mean a user interface screen on which a driving state of the robot 100 is displayed and output, and a command for operating the robot 100 is input from a user. The control screen may be displayed on the display unit under the control of the controller 20, and a display and an input command on the control screen may be controlled by the controller 20.

The input unit 18 may transmit information about an operation state to the controller 20 and receive a control command for operation from the controller 20. The input unit 18 may operate according to a control command received from the controller 20. That is, the input unit 18 may be controlled by the controller 20.

The obstacle detection unit 19 includes a plurality of sensors to detect obstacles located in a traveling direction. The obstacle detection unit 19 may detect an obstacle located in a forward direction of the main body 10, that is, in a traveling direction of the main body 10 using at least one selected from a laser sensor, an ultrasonic sensor, an infrared sensor, and a three-dimensional (3D) sensor. The obstacle detection unit 19 may further include a cliff detection sensor installed on a rear surface of the main body 10 to detect a cliff.

The obstacle detection unit 19 may transmit information regarding a result of detection to the controller 20, and receive a control command for operation from the controller 20. The obstacle detection unit 19 may operate according to the control command received from the controller 20. That is, the obstacle detection unit 19 may be controlled by the controller 20.

The weeding unit 30 cuts grass on the bottom while traveling. The weeding unit 30 is provided with a brush or blade for cutting a lawn, so as to cut the grass on the ground in a rotating manner.

The weeding unit 30 may transmit information about a result of operation to the controller 20 and receive a control command for operation from the controller 20. The weeding unit 30 may operate according to the control command received from the controller 20. That is, the weeding unit 30 may be controlled by the controller 20.

The controller 20 may include a central processing unit to control overall operation of the robot 100. The controller 20 may determine a status (or condition) of the travel area 100 while the robot 100 is traveling in the travel area 1000 via the main body 10, the driving unit 11, and the image capturing unit 12 to control traveling of the main body 10, and control functions and operation of the robot 100 to be performed via the communication unit 13, the output unit 14, the data unit 15, the sensing unit 16, the receiver 17, the input unit 18, the obstacle detection unit 19, and the weeding unit 30.

The controller 20 may control input and output of data and control the driving unit 11 so that the main body 10 travels according to settings. The controller 20 may independently control operation of the left wheel driving motor and the right wheel driving motor by controlling the driving unit 11 to thereby control the main body 10 to travel rotationally or in a straight line.

The controller 20 may set the boundary area 1200 of the travel area 1000 based on position information received from the terminal 300 or position information determined based on the signal received from the transmission device 200. The controller 20 may also set the boundary area 1200 of the travel area 1000 based on position information that is collected by the controller 20 during traveling. The controller 20 may set a certain area of a region formed by the set boundary area 1200 as the travel area 1000. The controller 20 may set the boundary area 1200 in a closed loop form by connecting discontinuous position information in a line or a curve, and set an inner area within the boundary area 1200 as the travel area 1000. When the travel area 1000 and the border area 1200 corresponding thereto are set, the controller 20 may control traveling of the main body 10 so that the main body 10 travels in the travel area 1000 without deviating from the set boundary area 1200. The controller 20 may determine a current position based on received position information and control the driving unit 11 so that the determined current position is located in the travel area 1000 to thereby control traveling of the main body 10.

In addition, according to obstacle information input by at least one of the image capturing unit 12, and the obstacle detection unit 19, the controller 20 may control the main body 10 to travel by avoiding obstacles. In this case, the controller 20 may modify the travel area 1000 by reflecting the obstacle information to pre-stored area information regarding the travel area 1000.

In the robot 100 having the configuration as illustrated in FIG. 7, when the controller 20 detects the target object in the travel area 1000 after determining a condition of the travel area 1000 based on the image information, the controller 20 may control the main body 10 to travel in response to the target object.

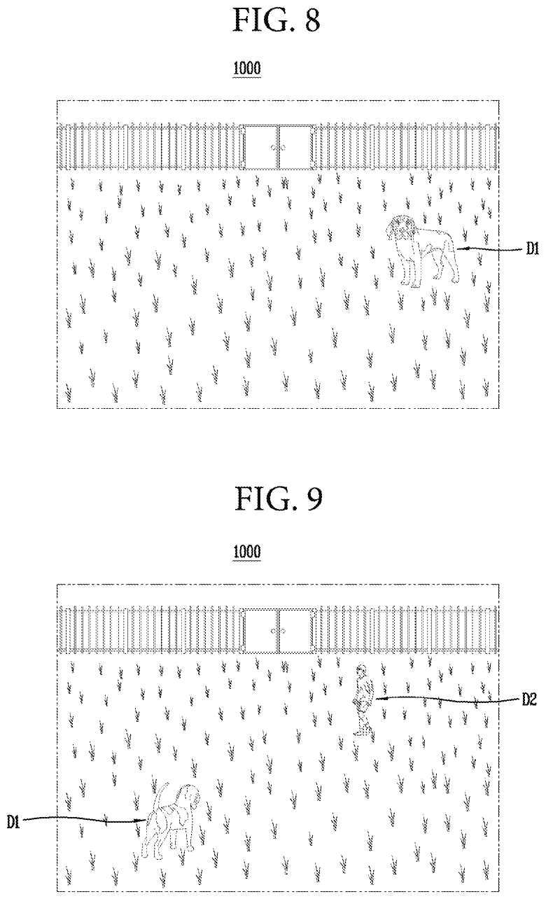

The robot 100 may perform set operation while traveling in the travel area 1000. For example, the robot 100 may cut a lawn on the bottom of the travel area 1000 while traveling in the travel area 1000, which is captured in images as illustrated in FIGS. 8 and 9.

In the robot 100, the main body 10 may travel according to driving of the driving unit 11. The main body 10 may travel as the driving unit 11 is driven to move the main body 10.

In the robot 100, the driving unit 11 may move the main body 10 according to driving of the driving wheels. The driving unit 11 may move the main body 10 by driving the driving wheels so that the main body 10 travels.

In the robot 100, the image capturing unit 12 may capture an image of a periphery of the main body 10 from a position where it is installed, and generate image information accordingly. The image capturing unit 12 may be provided at an upper portion of a rear side of the main body 10. By providing the image capturing unit 12 at the upper portion of the rear side of the main body 10, the image capturing unit 12 may be prevented from being contaminated by foreign material or dust generated by traveling of the main body 10 and lawn cutting. The image capturing unit 12 may capture an image of a traveling direction of the main body 10. That is, the image capturing unit 12 may capture an image of a forward direction of the main body 10 to travel, allowing an image of a condition ahead of the main body 10 to be captured. The image capturing unit 12 may capture an image around the main body 10 in real time to generate the image information while the main body 10 is traveling in the travel area 1000. In addition, the image capturing unit 12 may transmit a result of image capturing to the controller 20 in real time. Accordingly, the controller 20 may determine a real-time status of the travel area 1000.

In the robot 100, the controller 20 may control the driving unit 11 such that the main body 10 travels in the travel area 1000, and determine a condition (or status) of the travel area 1000 based on the image information to detect the target object D. The target object D refers to an object changing its position among objects present in the travel area 1000. That is, the target object D may be a dynamic obstacle such as a pet, a wild animal entering premises of the travel area 1000, a human, a robot, or the like. When the target object D changing its position in the travel area 1000 is detected after determining the condition of the travel area 1000 based on the image information, the controller 20 may control the main body 10 to travel in response to the target object D. That is, the controller 20 may determine whether the target object D is present in the travel area 1000 based on the image information. When the target object D is detected, the controller 20 may control the main body 10 to travel in response to the target object D.

The controller 20 may detect the target object D by recognizing an object changing its position among objects captured in the image information. That is, the controller 20 may recognize the object changing its position in the image information to detect the target object D. For example, when a position of an object D1 captured by the image capturing unit 12 and included in the image information of FIG. 8, is changed as illustrated in FIG. 9, the object D1 changing its position may be detected as the target object D. Alternatively, an object D2 not included in the image information of FIG. 8 is included in the image information of FIG. 9 as a position of the object D2 is changed, then the object D2 may also be detected as the target object D.

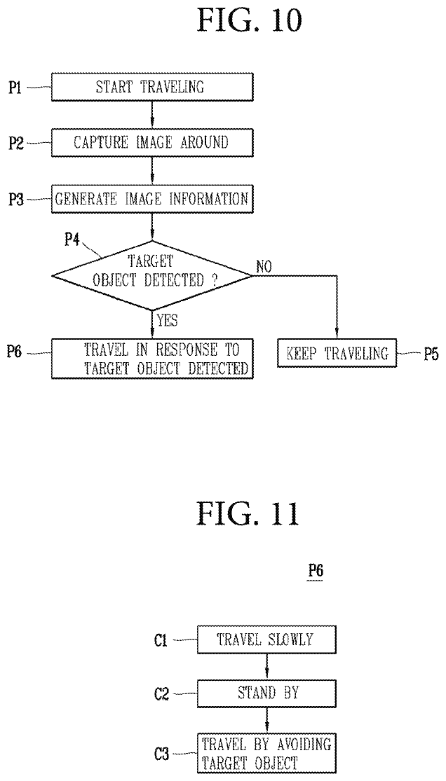

The robot 100 that detects the target object D and travels in response to the target object D may operate according to a process illustrated in FIG. 10, so as to travel in response to the target object D. As illustrated in FIG. 10, the robot 100 may operate in order from starting traveling P1, capturing an image around P2, generating image information P3, detecting a target object P4 to keeping traveling P5 or traveling in response to the target object (or responsive traveling) P6.

In the robot 100, the main body 10 starts traveling in the travel area 1000 (P1), and an image around the main body 10 is captured (P2) by the image capturing unit 12 to generate image information as shown in FIGS. 8 and 9. Based on the image information generated by the image capturing unit 12, the controller 20 may detect the target object D present in the travel area 1000. The controller 20 may control the main body 10 to keep travelling (P5) or to travel in response to the target object D (P6) according to whether the target object D is detected. An object changing its position like the object D1 and the object D2 in the image information captured sequentially from FIG. 8 to FIG. 9 may be detected as the target object D. That is, the controller 20 may recognize an object changing its position in the image information to detect the target object D. When the target object D is not detected, the controller 20 may control the main body 10 to keep traveling (P5). When the target object D is detected, the controller 20 may control the main body 10 to travel in response to the target object D. In other words, when a dynamic obstacle is not detected, the robot 100 may keep traveling (P5), and when the dynamic obstacle is detected, the robot 100 may travel in response to the dynamic obstacle (P6), for example, a stop, a change of traveling, and the like.

When the controller 20 controls the main body 10 to travel in response to the target object D (P6), the controller 20 may control the main body 10 according to at least one of a plurality of predetermined control modes. The control mode may be a mode configured to control traveling of the main body 10. For example, it may be a mode for controlling the main body 10 to stop, a mode for controlling the main body 10 to reduce a traveling speed, and the like.

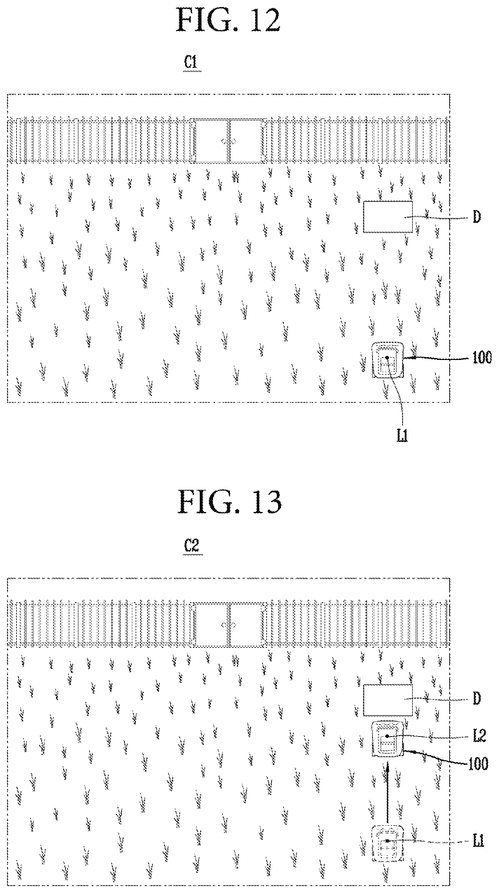

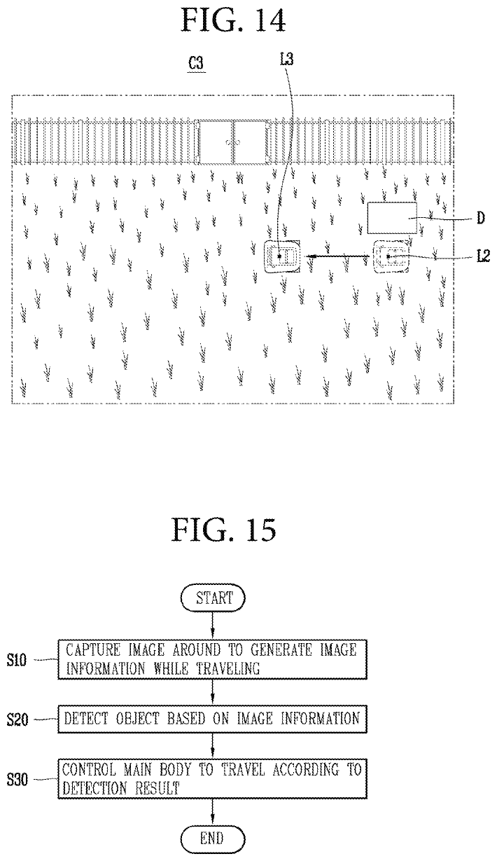

The controller 20 may control the main body 10 to travel in response to the target object D by combining one or more of the control modes. The plurality of control modes may include a first control mode for controlling the main body 10 to travel slowly, a second control mode for controlling the main body 10 to stand by (or stop), and a third control mode for controlling the main body 10 to travel by avoiding the target object D. That is, when the main body 10 is controlled to travel in response to the target object D, the controller 20 may control the main body 10 to travel by combining one or more of the first control mode, the second control mode, and the third control mode. Accordingly, the robot 100 may be operated by one or more of traveling slowly, standing by, and traveling to avoid in response to the target object D. Here, the controller 20 may control the main body 10 to perform a plurality of operations in order. For example, as shown in FIG. 11, the controller 20 may control traveling of the main body 10 according to one or more the plurality of control modes, so that the main body 10 is operated in order from travelling slowly C1, standing by C2, to avoiding C3. In more detail, for example, as shown in FIG. 12, the main body 10 is controlled to travel slowly C1 at a periphery L1 of the target object D according to the first control mode. When the main body 10 travels slowly (C1) and reaches a vicinity L2 of the target object D as shown in FIG. 13, the main body is controlled to stop and stand by (C2) in the vicinity L2 of the target object D according to the second control mode. If the target object D maintains its position, the main body 10 is controlled to travel in a different direction L3 from the target object D by avoiding the target object D (C3) according to the third control mode, as shown in FIG. 14. Accordingly, the robot 100 may travel in response to the target object D while performing the plurality of operations.

When the controller 20 controls the main body 10 to travel according to one or more of the plurality of control modes, the controller 20 may control such that at least a predetermined distance (or gap) between the main body 10 and the target object D is maintained. That is, the controller 20 controls the main body 10 to be spaced apart from the target object D by the predetermined distance when the main body 10 is controlled to travel according to the plurality of control modes. Here, the predetermined distance is a distance to ensure safety of the robot 100 and the target object D, which may be set by a user of the robot 100. Accordingly, when the robot 100 travels according to at least one of operations of traveling slowly, standing by, or traveling by avoiding in response to the target object D, a distance between the robot 100 and the target object D is secured by the predetermined distance.

The controller 20 may control the main body 10 to travel according to one or more of the plurality of control modes until the target object D is no longer sensed. In more detail, the controller 20 may control the main body 10 to travel in response to the target object D until the target object D is no longer present in the periphery of the main body 10 and is no longer captured by the image capturing unit 20.

When the target object D is detected as described above, the controller 20 that controls the main body 10 to travel in response to the target object D may control the main body 10 to travel according to a type of the target object D. For instance, traveling of the main body 10 may be controlled by combining one or more of the plurality of control modes according to the type of the target object D. The controller 20 may determine the type of the target object D based on a result of sensing the target object D and a predetermined detection reference (or criteria), so as to control the main body 10 to travel according to the type of the target object D. The detection reference may be characteristics and peculiarities of the target object D to determine the type of the target object D. Accordingly, the controller 20 may determine the characteristics and peculiarities of the target object D from a result of sensing the target object D, then compare a determined result with the detection reference to determine the type of the target object D. The controller 20 may also control the main body 10 to travel according to a predetermined control reference (or criteria) set based on the type of the target object D. That is, the controller 20 may determine the type of the target object D based on the result of detection, and determine a reference corresponding to the type of the target object D. Then, the controller 20 may control the main body 10 to travel in response to the target object D according to the determined control reference. Here, the control reference may be a reference for a combination of the plurality of control modes according to the type of the target object D. For example, when the target object D is a pet, it may be set to control the main body 10 to travel sequentially according to the first control mode, the second control, and the third control mode, so that the main body 10 travels in order from traveling slowly C1, standing by C2, to traveling by avoiding C3 as illustrated in FIG. 11. The type of the target object D and the control reference may be set by the user of the robot 100. For example, in the case of the control reference for the pet, it may be set to control the main body 10 to travel in different order from the order illustrated in FIG. 11, or a combination of different control modes.

When the target object D is detected as described above, the controller 20 controlling the main body 10 to travel in response to the target object D controls another configuration included in the robot 100, allowing operation in response to the target object D to be performed.

The robot 100 may further include the communication unit 13 that is to communicate with an external communication target element, and the controller 20 may generate notification information of a result of detecting the target object D. The notification information may be transmitted to the communication target element from the communication unit 13. Here, the communication target element may be the terminal 300 of the user or the like. That is, when the target object D is detected, the controller 20 may provide information of a result of detecting the target object D to the user of the robot 100 via the communication unit 13.

The robot 100 may further include the output unit 14 configured to output an audio output, and the controller 20 may generate an alarm signal so that an audible output is output from the output unit 14 according to the generated alarm signal. That is, when the target object D is detected, the controller 20 may control such that an alarm regarding a result of detecting the target object D is output from the output unit 14.

The robot 100 as described above may be implemented in a method for controlling a moving robot (hereinafter referred to as “control method”) to be described hereinafter.

The control method is a method for controlling the moving robot 100 as shown in FIGS. 1-3, which may be applied to the robot 100. It may also be applied to robots other than the robot 100.

The control method may be a method for controlling the robot 100 including the main body 10, the driving unit 11 moving the main body 10, the image capturing unit 12 capturing an image of a periphery of the main body 10, and the controller 20 controlling the driving unit 11 to control traveling of the main body 10 and determining a condition (or status) of the travel area 1000 based on an image captured by the image capturing unit 12, which may be a method for controlling the robot 100 to travel by detecting the target object D.

The control method may be a method in which the controller 20 controls operation of the robot 100.

The control method may be a method performed by the controller 20.

As shown in FIG. 15, the control method may include generating image information by capturing an image around the main body 10 while the moving robot 100 travels in the travel area 1000 (S10), detecting the target object D changing its position in the travel area 1000 based on the image information (S20), and controlling the main body 10 to travel according to a result of the detection (S30).

That is, the robot 100 may be controlled in order from the generating (S10), the detecting (S20), to the controlling (S30).

In the generating step S10, the image capturing unit 12 may capture an image around the main body 10 to generate the image information while the robot 100 is traveling in the travel area 1000.

That is, in the generating step S10, the controller 20 may control the image capturing unit 12 to capture an image around the main body 10 and generate the image information.

In the generating step S10, the image capturing unit 20 may capture an image of a forward direction of the main body 10 to generate the image information.

In the generating step S10, the image capturing unit 12 may capture an image around the main body 10 in real time to generate the image information while the main body 10 is traveling in the travel area 1000.

In the detecting step S20, the controller 20 may detect the target object D based on the image information generated at the generating step S10.

That is, in the detecting step S20, the controller 20 may detect an object corresponding to the target object D in the image information generated by the image capturing unit 12.

In the detecting step S20, an object changing its position among objects captured in the image information may be recognized, and the recognized object may be detected as the target object D.

In the detecting step S20, after determining a condition of the travel area 1000 based on the image information, when an object changing its position in the travel area 1000 is recognized, the recognized object may be detected as the target object D.

In the controlling step S30, the controller 20 may control the main body 10 to travel according to a result detected at the detecting step S20.

That is, in the controlling step S30, the controller 20 may control the main body 10 to travel based on a result of detecting the target object D.

In the controlling step S30, when the target object D is not detected, the main body 10 may be controlled to keep travelling.

In other words, in the controlling step S30, when the target object D is not detected, the main body 10 may be controlled to maintain its traveling and operation, which are currently being performed.

In the controlling step S30, when the target object D is detected, the main body 10 may be controlled to travel in response to the target object D.

In the controlling step S30, a type of the target object D may be determined based on the result of detection and a predetermined detection reference (or criteria) to control travelling of the main body 10 according to the type of the target object D.

In the controlling step S30, characteristics and peculiarities of the target object D may be determined according to the result of detecting the target object D, and a determined result is compared with the detection reference to determine the type of target object D.

In the controlling step S30, travelling of the main body 10 may be controlled based on a predetermined control reference (or criteria) according to the type of the target object D.

In the controlling step S30, a control reference that corresponds to the type of the target object D may be determined to control the main body 10 to travel accordingly.

In the controlling step S30, when the main body 10 is controlled to travel in response to the target object D, traveling of the main body 10 may be controlled according to one or more of a plurality of predetermined control modes.

In the controlling step S30, when the main body 10 is controlled to travel in response to the target object D, a first control mode for controlling the main body 10 to travel slowly, a second control mode for controlling the main body 10 to stand by, and a third control mode for controlling the main body 10 to travel by avoiding the target object D.

In the controlling step S30, the main body 10 may be controlled to travel in response to the target object D by combining one or more of the control modes.

In the controlling step S30, when traveling of the main body 10 is controlled according to at least one of the plurality of control modes, the main body 10 is controlled to travel while maintaining at least a predetermined distance between the main body 10 and the target object D.

In the controlling step S30, traveling of the main body 10 may be controlled according to one or more of the plurality of control modes until the target object D is no longer detected.

In the controlling step S30, when the target object D is detected, notification information of a result of detecting the target object D may be generated to transmit the notification information to the communication target element from the communication unit 13.

In the controlling step S30, when the target object D is detected, an alarm signal for the detected target object D is generated so that an audible output is output from the output unit 14 included in the robot 100 according to the alarm signal.

The control method that includes the generating (S10), the detecting (S20), and the controlling (S30) can be implemented as computer-readable codes on a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. The computer-readable medium may also be implemented as a format of carrier wave (e.g., transmission via an Internet). The computer may also include the controller 20.

The above-described embodiments of the moving robot and the method for controlling the moving robot according to the present disclosure may be applied and implemented with respect to a control element for a moving robot, a moving robot system, a control system of a moving robot, a method for controlling a moving robot, a method for detecting an obstacle of a moving robot, and a method for detecting a dynamic obstacle of a moving robot, etc. In particular, the above-described embodiments may be usefully applied and implemented with respect to Artificial Intelligence (AI) for controlling a moving robot, a control element for a moving robot employing and utilizing AI, and a control method for a moving robot employing and utilizing AI, a moving robot employing and utilizing AI, or the like. However, the technology disclosed in this specification is not limited thereto, and may be implemented in any moving robot, a control element for a moving robot, a moving robot system, a method for controlling a moving robot, or the like to which the technical idea of the above-described technology may be applied.

While the present disclosure has been particularly shown and described with reference to embodiments thereof, it will be understood that various changes in form and details may be made therein without departing from the spirit and scope of the present disclosure as defined by the following claims. Therefore, the scope of the present disclosure should not be limited by the described embodiments, but should be determined by the scope of the appended claims and equivalents thereof.

While the present disclosure has been particularly shown and described with reference to exemplary embodiments, described herein, and drawings, it may be understood by one of ordinary skill in the art that various changes and modifications thereof may be made. Therefore, the scope of the present disclosure should be defined by the following claims, and various changes equal or equivalent to the claims pertain to the category of the concept of the present disclosure.

What is claimed is:

1. A robot, comprising:
a main body;
a driving unit configured to move the main body;
an image capturing unit configured to capture an image of a travel area around the main body to generate image information regarding the travel area of the main body; and
a controller configured to:
control traveling of the main body by determining a condition of the travel area based on the captured image while the main body is traveling in the travel area,
detect a target object changing its position in the travel area after determining the condition of the travel area while the main body is traveling in the travel area, and
control the main body to travel in response to the detection of the target object changing its position in the travel area.

2. The robot of claim 1, wherein the image capturing unit is disposed at an upper portion of a rear side of the main body.

3. The robot of claim 1, wherein the image capturing unit is configured to capture an image of a traveling direction of the main body.

4. The robot of claim 1, wherein the controller is configured to detect an object changing its position among objects captured in the image information, and identify the detected object as the target object.

5. The robot of claim 1, wherein the controller is configured to control the main body to travel in response to detection of the target object based on a plurality of preset control modes.

6. The robot of claim 5, wherein the plurality of control modes comprises:
a first control mode configured to control the main body to travel slowly;
a second control mode configured to control the main body to stand by; and
a third control mode configured to control the main body to travel by avoiding the target object.

7. The robot of claim 6, wherein the controller is configured to control the main body to travel while maintaining at least a predetermined distance between the main body and the target object, when the main body is controlled to travel according to one or more of the plurality of control modes.

8. The robot of claim 5, wherein the controller is configured to control the main body to travel according to one or more of the plurality of control modes until the target object is no longer detected.

9. The robot of claim 1, wherein the controller is configured to determine a type of the target object based on a result of detecting the target object and comparing the detected target object with a predetermined detection reference, and control the main body to travel according to the determined type of the target object.

10. The robot of claim 1, further comprising a communication unit configured to communicate with an external communication target element,
wherein the controller is configured to generate notification information of a result of detecting the target object, and transmit the notification information to the communication target element from the communication unit.

11. The robot of claim 1, further comprising an output unit configured to output an audio output,
wherein the controller is configured to generate an alarm signal based on a result of detecting the target object, so that an audio output is output from the output unit based on the alarm signal.

12. A method for controlling a robot including a main body, a driving unit configured to move the main body, an image capturing unit configured to capture an image around the main body to generate image information regarding a travel area of the main body, and a controller configured to control traveling of the main body by controlling the driving unit and determine a condition of the travel area based on the image information, the method comprising:
generating image information by capturing an image around the main body while the robot is traveling in the travel area;
detecting a target object changing its position in the travel area based on the image information; and
controlling the main body to travel based on a result of the detection.

13. The method of claim 12, wherein detecting the target object changing its position in the travel area based on the image information includes detecting the target object among objects captured in the image information by recognizing that the target object is changing its position.

14. The method of claim 12, wherein controlling the main body to travel based on the result of the detection includes controlling the main body to travel in response to movement of the target object when the target object is detected.

15. The method of claim 14, wherein controlling the main body to travel based on the result of the detection includes determining a type of the target object based on a comparison of the result of the detection and a predetermined detection reference, and controlling the main body to travel based on the determined type of the target object.

16. The method of claim 15, wherein controlling the main body to travel includes at least one of control modes, comprising:
a first control mode configured to control the main body to travel slowly;
a second control mode configured to control the main body to stand by; and
a third control mode configured to control the main body to travel by avoiding the target object.

17. A robot, comprising:
a main body;
a driving unit configured to move the main body;
an image capturing unit configured to capture an image of a travel area around the main body to generate image information regarding the travel area of the main body; and
a controller configured to:
control traveling of the main body by determining a condition of the travel area based on the captured image while the main body is traveling in the travel area,
detect a target object changing its position in the travel area,
determine a type of the target object based on a result of detecting the target object and comparing the detected target object with a predetermined detection reference, and
control the main body to travel in response to the detection of the target object changing its position in the travel area, wherein the control of the main body to travel in response to the detection of the target object is based on a plurality of preset control modes and the determined type of the target object.

18. The robot according to claim 17, further comprising a communication unit configured to communicate with an external communication target element,
wherein the controller is configured to generate notification information of a result of detecting the target object, and transmit the notification information to the communication target element from the communication unit.

19. The robot according to claim 17, further comprising an output unit configured to output an audio output,
wherein the controller is configured to generate an alarm signal based on a result of detecting the target object, so that an audio output is output from the output unit based on the alarm signal.

20. The robot according to claim 17, wherein the plurality of control modes comprises:
a first control mode configured to control the main body to travel slowly;
a second control mode configured to control the main body to stand by; and
a third control mode configured to control the main body to travel by avoiding the target object.
